(19) United States
(12) Patent Application Publication
(10) Pub. No.: US 2024/0399788 A1
(43) Pub. Date: Dec. 5, 2024

(54) WHEEL DISC FOR A DISC WHEEL AND A DISC WHEEL THEREWITH

(71) Applicant: Maxion Wheels Holding GmbH, Königswinter (DE)

(72) Inventors: Achim Boos, Lohmar (DE); Alexandre Andre Costa Motta, São José do Alegre (BR)

(73) Assignee: Maxion Wheels Holding GmbH, Königswinter (DE)

(21) Appl. No.: 18/691,174

(22) PCT Filed: Sep. 27, 2022
(86) PCT No.: PCT/IB2022/059156

§ 371 Date: Mar. 12, 2024

(30) Foreign Application Priority Data
Sep. 30, 2021 (DE) 10 2021 125 383.7

(51) Int. Cl. B60B 3/10; B60B 3/04

(52) U.S. Cl. CPC B60B 3/10; B60B 3/04

(57) ABSTRACT

A wheel disc for a wheel with a radially extending hub connection flange and a disc rim connected to a wheel rim and a transition region extending between the disc rim and the connection flange. The transition region is provided with ventilation holes. The holes extend in the radial direction from a first inner pitch circle located closer to the connection flange to a second outer pitch circle located closer to the rim. The transition region in the radial section in a first sectional area extending between the connection flange and the radially inner first pitch circle has a material thickness reduced by at least 30% compared to a material thickness of the connection flange and/or wherein the holes have a hole region with a hole width increasing in the circumferential direction of the disc from the radially inner, first pitch circle towards the radially outer, second pitch circle.

### CROSS-REFERENCE TO RELATED APPLICATIONS

This application is a national stage of International Application No. PCT/IB2022/059156, filed 27 Sep. 2022, the disclosures of which are incorporated herein by reference in entirety, and which claimed priority to German Patent Application No. 10 2021 125 383.7, filed 30 Sep. 2021, the disclosures of which are incorporated herein by reference in entirety.

### BACKGROUND TO THE INVENTION

The invention relates to a wheel disc for a disc wheel, in particular for commercial vehicles, with an at least essentially radially extending hub connection flange and with an essentially cylindrical disc rim that can be connected to a wheel rim and with a transition region extending between the disc rim and the hub connection flange. The invention is further directed to a disc wheel, in particular for commercial vehicles, that is equipped with such a wheel disc.

Disc wheels, which are nowadays mainly used for commercial vehicles, essentially consist of two steel moulded parts, namely a wheel rim and a wheel disc, which can be fixed to a wheel hub of the vehicle by means of a hub connection flange extending at least essentially radially by means of wheel bolts or nuts. The wheel disc comprises an essentially cylindrical, circumferential disc rim with which it is welded to a connection region on the inner circumference of the wheel rim. The manufacture of the wheel disc usually takes place on a flow-forming machine by flow-forming or shear-forming by clamping a steel preform in the region of the hub connection flange between an end face of a flow-forming chuck and a hold-down device. The material adjoining the hub connection flange radially outwardly, which may already have been preformed, is subsequently pressed against a flow-forming chuck and stretched by means of spinning rollers as the preform rotates, in order to obtain the desired contour of the transition region and of the disc rim forming at its end. Wheel discs manufactured by flow-forming or shear-forming have uniform surfaces and a good microstructure on their inner and outer sides, whereby they can transmit the loads occurring during vehicle operation well between the rim and the vehicle hub. Methods and devices for flow-forming or shear-forming for the manufacture of wheel discs for vehicle wheels are known, for example, from DE 21 56 551, DL 196 15 675 A1, DE 198 60 732 A1 or EP 1 473 097 B1.

A wheel disc of the generic type for a corresponding disc wheel is known from DE 20 2014 104 068 U, in which the transition region between the central hub connection flange and the radially outer disc rim is subdivided into at least five sections which merge into one another or into the hub connection flange or the disc rim, wherein the sections have a curvature over at least a partial region of their length between their outer and inner end and the curvatures of sections adjacent to one another have different directions of curvature. Thereby, the arrangement is made in such a manner that the individual sections have a greater radial distance from an axis of rotation of the wheel disc at their inner ends than at their outer ends, wherein the wheel disc has a variable material strength in its transition region and the ratios of the material strengths of the individual sections are defined in certain ratios to one another.

Vehicle wheels influence in a not inconsiderable manner not only the driving behaviour of the vehicle equipped with them, but also to a considerable extent determine its fuel consumption and the achievable load capacity. Thereby, a weight of the individual wheels as low as possible has an advantageous effect on the driving behaviour and the consumption. However, weight minimization is regularly associated with a reduction in the material thickness of the wheel disc, whereby stresses in the material are increased, which in turn can have a detrimental effect on load capacity. Even though the known wheel and the wheel disc used therein have proved to be very successful, they can still be improved in terms of their weight.

### SUMMARY OF THE INVENTION

A feature of the invention is to create a wheel disc and a disc wheel provided therewith, wherein on the one hand the lowest possible weight of the wheel can be realized, and on the other hand the strength requirements placed on the wheel disc or the disc wheel provided therewith are reliably fulfilled.

This feature is solved with the invention with a wheel disc of the above mentioned type in that the transition region is provided with ventilation holes distributed over the circumference, wherein the ventilation holes extend in the radial direction from a first inner pitch circle located closer to the connection flange to a second outer pitch circle located closer to the rim edge, wherein the transition region in the radial section in a first sectional area extending between the hub connection flange and the radially inner first pitch circle has a material thickness reduced by at least 30% in relation to a material thickness of the wheel fastening flange and/or wherein the ventilation holes have a hole region with a hole width (b) increasing from the radially inner first pitch circle towards the radially outer second pitch circle. The disc wheel according to the invention is in particular suitable for commercial vehicles and has a wheel rim having an inner rim well base and two axially outer rim shoulders with rim flanges delimiting these at the outer and inner rim of the rim and an essentially cylindrical connection region arranged between one of the rim shoulders and the rim well base, to the inner side of which connection region the disc rim of the wheel disc according the invention is connected, in particular welded.

The wheel disc according to the invention, the special design of which was developed by elaborate finite element methods, is characterized on the one hand by a particularly advantageous material thickness distribution of the disc wall and on the other hand by a special design and arrangement of the ventilation holes provided in the transition region of the wheel disc between the hub connection flange and the disc rim. Surprisingly, it has been shown that in the radially inner part of the transition region, a considerable reduction in the material thickness of the wheel disc material by more than 30%, compared with the material thickness at the central wheel connection flange, results in a considerable reduction in stresses, especially in this region of the disc, whereby an appreciable reduction of the component weight can be achieved while ensuring the required strength. A significant reduction in weight, while also ensuring very good strength, is achieved by the special shape of the ventilation holes, which can be described as approximately drop-shaped. The shape of the ventilation holes with a drop point pointing radially inward towards the connection flange and a hole cross section that widens radially outward starting from the inner pitch circle has proved to be very advantageous for the stress course in the transition region, especially in the material webs (spokes) present between adjacent holes, in that stress peaks are avoided hereby and a high load-carrying capacity can be achieved with comparatively low weight. Tests have shown that, with the measures according to the invention, it is possible to reduce the mass of a disc wheel by about 15% compared with conventional designs while retaining the same load-bearing capacity, and thereby to enable a significant improvement in the fuel efficiency of a vehicle equipped with such a wheel as well as better driving behaviour.

In an advantageous configuration of the invention, the ratio of the material thickness in the radially inner sectional area of the first pitch circle to the material thickness of the hub connection flange can be at most 0.6, preferably no more than 0.5, and in particular less than 0.46. The material thickness in the radially inner sectional area, which, in the sense of the invention, is to be defined as the dimension perpendicular to the outer and inner side of the wheel disc, can thus be less than half the (usual) thickness at the hub connection flange, which actually results in a very considerable weight saving!

In an advantageous, constructive further development of the invention, it can be provided that a material thickness of the transition region on the first pitch circle is at least 50% of the material thickness of the hub connection flange. Finite element simulation of the design has shown that this ensures very good strength of the wheel disc in the load cases considered, despite the ventilation holes on the first pitch circle. Preferably, the ratio of the material thickness at the first pitch circle to the material thickness at the hub connection flange is selected to be greater than 0.54.

When dimensioning the ventilation holes, it was found that the maximum hole width of the ventilation holes is preferably at most 85% of their hole height measured in the radial direction, in particular preferably at most 80/%. The maximum hole width of the ventilation holes can preferably be located on a third pitch circle, which is located between the first inner pitch circle and the second outer pitch circle. Thereby, the distance between the third pitch circle and the first pitch circle is expediently at most as large and preferably smaller than the distance between the second and the third pitch circle. In this particularly preferred design, the basic shape of the ventilation hole can also be described as egg-shaped.

The ratio of the distance between the first and third pitch circle and the hole height of the ventilation holes is preferably less than or equal to 0.48, in particular less than or equal to 0.47.

As has already been explained, the ventilation holes preferably have an approximately drop- or egg-shaped basic shape with a hole tip facing the first, inner pitch circle, which tip preferably has a narrow radius of curvature, and with a flattening located towards the second, outer pitch circle, which flattening has a second, larger radius of curvature. The ventilation holes are preferably respectively axially symmetrical to the radial plane defining the hole height.

In an advantageous further development of the shape of the ventilation holes, they can have a hole edge curvature between their hole tip and their maximum hole width which, starting from the narrow radius of curvature of the hole tip, increases to at least 6 times, preferably more than 8 times, of the hole tip radius. In a transition region to the maximum hole width, the hole rim curvature can be about 1.5 to 3 times, preferably more than twice of the narrow radius of curvature of the hole tip.

In a disc wheel according to the invention, which is provided with a wheel disc of the type explained above, a preferred embodiment is that a circumferential hump is arranged between the connection region and the rim shoulder adjacent thereto, which hump can reliably prevent the tyre foot of a tyre mounted on the wheel from slipping into the rim well base in the event of large lateral forces occurring. It is thereby particularly advantageous if the hump has an elevation on a part of its circumference with a steep flank facing the connection region, the height and width of which flank is adapted to the arrangement of a valve hole for a tyre inflation valve. That way, an externally accessible inflation valve can be realized even if the height of the hump is selected to be comparatively low and thus a free space between the disc rim and the opposite rim shoulder is comparatively narrow and unhindered access to the valve would be difficult or even impossible without the elevation.

Other advantages of this invention will become apparent to those skilled in the art from the following detailed description of the preferred embodiments, when read in light of the accompanying drawings.

### BRIEF DESCRIPTION OF THE DRAWINGS

FIG. 1 is an upper half or generatrix of a wheel disc of a steel disc wheel according to the invention in radial section;

FIG. 2 is a representation of one of the ventilation holes in the transition region of the wheel disc according to the invention; and

FIG. 3 is the disc wheel according to the invention in a radial section representation of the upper half of the wheel.

### DETAILED DESCRIPTION OF THE INVENTION

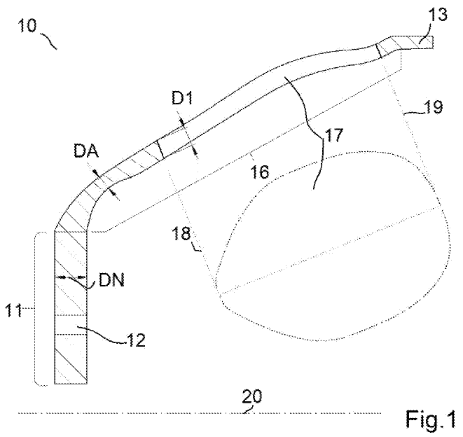

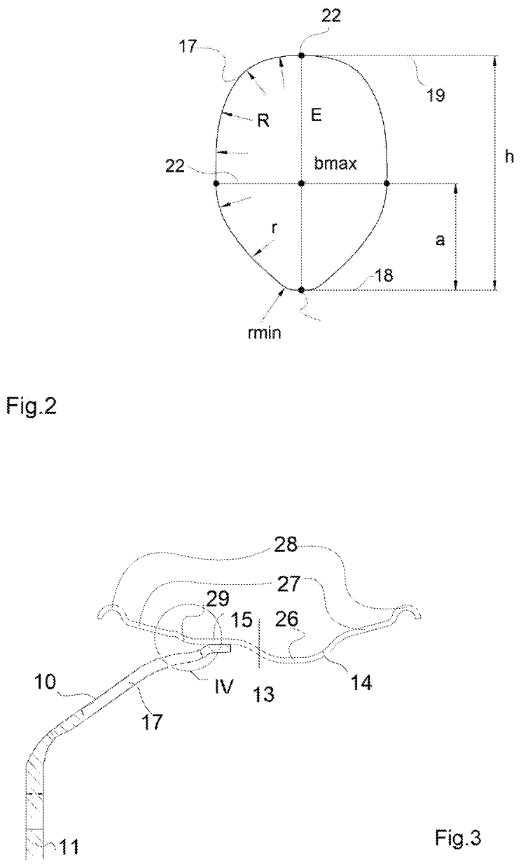

FIG. 1 shows a radial section (generatrix) of an upper half of a wheel disc 10 according to the invention, which in a known manner has a radially extending hub connection flange 11 with several bolt holes 12, by means of which the wheel provided with the wheel disc 10 can be fastened to a wheel hub, not shown, of a commercial vehicle.

The wheel disc 10 further has a cylindrical disc rim 13, with which it is welded to a wheel rim 14 (FIG. 3) at a connection region 15, which in the wheel according to the invention shown is located laterally next to a rim well base, as will be described in detail below.

Between the disc rim 13 and the hub connection flange 11 extends a transition region 16 connecting the two parts 11, 13, the particular design of which transition region is an essential characteristic of the present invention.

As can be seen from the drawing, several ventilation holes 17 are provided in the transition region 16, which holes are evenly distributed around the disc circumference and extend in the radially outer section of the transition region 16, which is located further out towards the disc rim, between a radially inner first pitch circle 18 and a second, radially outer pitch circle 19. At their inner end pointing radially inward toward the axis of rotation 20 of the wheel, the ventilation holes 17 are essentially pointed with a rounded hole tip 21 with a comparatively narrow hole tip radius rmin. Starting from the first, inner pitch circle 18 towards the second, outer pitch circle 19, the hole width of the ventilation holes increases, and namely to a maximum hole width bmax, which lies on a third pitch circle 22, which is located between the first and the second pitch circle 18, 19. In the preferred embodiment of the invention, the ratio of the distance a between the first and the third pitch circle to the hole height h of the ventilation holes 17, thus the distance between the first and second pitch circle, is thereby less than/equal to 0.47. The maximum width bmax of the ventilation holes 17 is thus closer to the first than to the second pitch circle. In their respective radially outer region, the ventilation holes are provided with a flattening 23 located towards the second pitch circle 19, which flattening merges with outer radii of curvature R into lateral hole regions.

The ventilation holes are axially symmetrical to the radial plane E defining the hole height h. In the radially more inner hole region of the ventilation holes between the hole tip 21 and the maximum hole width bmax on the third pitch circle 22, the hole rim curvature r increases from the narrow (minimum) radius of curvature rmin to about 8 times thereof, in order to then decrease again to about 2.5 times of the hole tip radius rmin in the transition region to the maximum hole width. Thus, in the lower, radially inner part of the ventilation holes, an approximately triangular wall shape results, as in an isosceles triangle. The overall shape of the ventilation holes can be described as drop- or egg-shaped.

In addition to the special shape of the ventilation holes, the design of the wheel disc according to the invention is characterized by a special ratio of the material thickness in the sectional area 24 lying radially inward of the first pitch circle 18 to the material thickness at the hub connection flange 11, wherein this material thickness ratio explained below has an independent inventive character. As can be seen in particular in FIG. 1, the material thickness DN at the hub connection flange is essentially constant. In the sectional area 24 adjoining the hub connection flange 11 on the outside, the material thickness DA continuously reduces to less than 0.46 of the material thickness DN at the hub connection flange, wherein this minimum material thickness DA is reached approximately halfway between the transition from the hub connection flange 11 to the inner sectional area 24 and the first pitch circle 18. From there, the thickness increases again to a value D1, which then reaches at least 50% of the material thickness DN at the hub connection flange at the first pitch circle 18 and which is preferably greater than 0.54 times of the thickness DN at the hub connection flange there. By reducing the material thickness in the sectional area 24 lying radially inward of the first pitch circle 18 to less than half, actually less than 46%, of the thickness DN of the hub connection, stresses in this part of the wheel disc 10 are minimized and, surprisingly, a particularly good stability of the wheel is achieved with a reduced weight compared to known wheels. The special design of the ventilation holes 17, which have a larger cross section than the holes in known wheels, also contribute significantly to the weight reduction without adversely affecting the stability of the wheel or its wheel disc.

FIG. 3 shows a vehicle wheel 25 which is advantageously equipped with the wheel disc 10 described above. The wheel rim 14 used with the vehicle wheel 25 has an inner rim well base 26, two axially outer rim shoulders 27 and rim flanges 28 delimiting these on the outer and inner rim of the rim 14. The connection region 15 for the disc rim 13 of the wheel disc is arranged between the rim well base 26 and the outer rim shoulder 27A. The disc rim 13 is welded to the rim in a known manner on the inside of the connection region over its circumference. A circumferential, comparatively low hump 29 is formed between the connection region 15 and the outer rim shoulder 27A, which hump prevents unintentional slipping of a tyre mounted on the rim into the rim well base, for example during brisk cornering, as is known.

In accordance with the provisions of the patent statutes, the principle and mode of operation of this invention have been explained and illustrated in its preferred embodiments. However, it must be understood that this invention may be practiced otherwise than as specifically explained and illustrated without departing from its spirit or scope.

1. A wheel disc for a disc wheel for commercial vehicles, with an at least essentially radially extending hub connection flange and with an essentially cylindrical disc rim which can be connected to a wheel rim and with a transition region extending between the disc rim and the hub connection flange, wherein the transition region is provided with ventilation holes distributed over a circumference, wherein the ventilation holes extend in a radial direction from a first inner pitch circle located closer to the connection flange to a second outer pitch circle located closer to the disc rim, wherein the transition region in radial section in a first sectional area extending between the hub connection flange and the radially inner first pitch circle has a material thickness reduced by at least 30% in relation to a material thickness of the hub connection flange and/or wherein the ventilation holes have a hole region with a hole width in disc circumference direction increasing from the radially inner first pitch circle towards the radially outer second pitch circle.

2. The wheel disc according to claim 1, wherein a ratio of the material thickness in the first sectional area to the material thickness of the hub connection flange is at most 0.6.

3. The wheel disc according to claim 1, wherein a material thickness of the transition region at the first pitch circle is at least 50% of the material thickness of the hub connection flange.

4. The wheel disc according to claim 3, wherein a ratio of the material thickness at the first pitch circle (18) to the material thickness at the hub connection flange is greater than 0.54.

5. The wheel disc according to claim 1, wherein a maximum hole width of the ventilation holes is at most 85% of a hole height thereof measured in the radial direction.

6. The wheel disc according to claim 1, wherein a maximum hole width of the ventilation holes lies on a third pitch circle between the first inner pitch circle and the second outer pitch circle, wherein a distance between the third pitch circle and the first pitch circle is at most as great the distance between the second pitch circle and the third pitch circle.

7. The wheel disc according to claim 6, wherein the ratio of the distance between the first pitch circle and the third pitch circle and a hole height of the ventilation holes is smaller than/equal to 0.48.

8. The wheel disc according to claim 1, wherein the ventilation holes have an approximately drop- or egg-shaped basic shape with a hole tip pointing towards the first, inner pitch circle having a narrow radius of curvature, and a flattening located towards the second, outer pitch circle having a second radius of curvature.

9. The wheel disc according to claim 1, wherein the ventilation holes are respectively axially symmetrical with respect to a radial plane defining a hole height of the ventilation holes.

10. The wheel disc according to claim 8, wherein the ventilation holes have a hole rim curvature between their hole tip and their maximum hole width, which curvature, starting from the narrow radius of curvature of the hole tip, increases to at least 6 times more than of the hole tip radius.

11. Wheel disc according to claim 10, wherein the hole rim curvature in a transition region to the maximum hole width is approximately 1.5 to 3 times of the narrow radius of curvature of the hole tip.

12. A disc wheel for commercial vehicles, with a wheel rim having an inner rim well base and two axially outer rim shoulders with rim flanges delimiting these at the outer and inner rim of the rim and an essentially cylindrical connection region arranged between one of the rim shoulders and the rim well base, to the inner side of which connection region the disc rim of a wheel disc according to claim 1.

13. The disc wheel according to claim 12, wherein a circumferential hump is arranged between the connection region and the rim shoulder adjacent thereto.
